(19) United States
(12) Patent Application Publication
(10) Pub. No.: US 2023/0309010 A1
(43) Pub. Date: Sep. 28, 2023

(54) Ultrafast Cell Selection In A Wireless Device

(71) Applicant: MediaTek Inc., Hsinchu City (TW)

(72) Inventors: Po-Wen Hsiao, Hsinchu City (TW); Pei-Tsung Wu, Hsinchu City (TW)

(21) Appl. No.: 18/108,906

(22) Filed: Feb. 13, 2023

Related U.S. Application Data
(60) Provisional application No. 63/322,248, filed on Mar. 22, 2022.

(51) Int. Cl. H04W 48/20; H04W 56/00

(52) U.S. Cl. CPC H04W 48/20; H04W 56/001

(57) ABSTRACT

Various pertaining to ultrafast cell selection in a wireless device are described. An apparatus stores information related to at least one of: (a) one or more ever-camped cells having been camped on by the apparatus previously, and (b) one or more ever-detected cells having been detected by the apparatus previously. The apparatus performs a cell selection procedure using the stored information responsive to occurrence of an event, thereby reducing cell search time, master information block (MIB) decoding time and system information block (SIB) decoding time.

### CROSS REFERENCE TO RELATED PATENT APPLICATIONS

The present disclosure is part of a non-provisional patent application claiming the priority benefit of U.S. Provisional Patent Application No. 63/322,248, filed 22 Mar. 2022, the content of which herein being incorporated by reference in its entirety.

### TECHNICAL FIELD

The present disclosure is generally related to wireless communications and, more particularly, to ultrafast cell selection in a wireless device.

### BACKGROUND

Unless otherwise indicated herein, approaches described in this section are not prior art to the claims listed below and are not admitted as prior art by inclusion in this section.

In wireless communications, when a wireless device needs to associate with a wireless network having one or more cells, the device can use its stored information or initial carrier frequencies to detect the physical-layer cell identity (PCI), and this procedure is referred to as cell search. In case that a cell is detected, the device needs to perform master information block (MIB) and system information block (SIB) decoding for the cell. For a 5th Generation (5G) New Radio (NR) cell, the device decodes SIB1. For a 4th Generation (4G) Long-Term Evolution (LTE) cell, the device decodes SIB1 and SIB2. After successful decoding of the MIB and SIB, the device is to evaluate whether the cell meets a suitable condition for the device to associate with that cell and, in case of a positive determination, the device associated with that cell as a serving cell. At this point, the device can be referred to as being camped on the serving cell in the wireless network of cells. The aforementioned operations together may be referred to as a cell selection procedure.

However, when certain events occur frequently, the cell selection procedure could result in delay and thereby negatively impacting user experience. Such events can include, for example: (i) power cycle for device power saving, (ii) wireless interface switching on and off for device power saving, (iii) non-access stratum (NAS)-triggered search for device selection of a different network, and (iv) radio resource control (RRC) release to idle search as required by 3rd Generation Partnership Project (3GPP) Technical Specification (TS) 36.331 and 38.331. Therefore, there is a need for a solution of ultrafast cell selection in a wireless device to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to ultrafast cell selection in a wireless device. Under various proposed schemes in accordance with the present disclosure, it is believed that undesirable delay in cell selection due to frequent occurrence of certain events may be avoided or otherwise alleviated.

In one aspect, a method may involve a processor of an apparatus storing information related to at least one of: (a) one or more ever-camped cells having been camped on by the apparatus previously, and (b) one or more ever-detected cells having been detected by the apparatus previously. The method may also involve the processor performing a cell selection procedure using the stored information responsive to occurrence of an event.

In another aspect, an apparatus may include a wireless interface, a memory and a processor coupled to the wireless interface and the memory. The processor may store, in the memory, information related to at least one of: (a) one or more ever-camped cells having been camped on by the apparatus previously, and (b) one or more ever-detected cells having been detected by the apparatus previously. The processor may perform, via the wireless interface, a cell selection procedure using the stored information responsive to occurrence of an event.

It is noteworthy that, although description provided herein may be in the context of certain radio access technologies, networks and network topologies such as, Wi-Fi and Bluetooth, the proposed concepts, schemes and any variation(s)/derivative(s) thereof may be implemented in, for and by other types of radio access technologies, networks and network topologies such as, for example and without limitation, ZigBee, 5G NR, LTE, LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example scenario under a proposed scheme in accordance with the present disclosure.

FIG. 2 is a diagram of an example scenario under another proposed scheme in accordance with the present disclosure.

FIG. 3 is a schematic diagram of an example apparatus in accordance with an implementation of the present disclosure.

FIG. 4 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to ultrafast cell selection in a wireless device. According to the present disclosure, a number of possible solutions may be implemented separately or jointly. That is, although these possible solutions may be described below separately, two or more of these possible solutions may be implemented in one combination or another.

Under various proposed schemes in accordance with the present disclosure, to improve the cell selection procedure, a novel ultrafast cell selection method may be utilized. It is believed that the ultrafast cell selection method may reduce cell search time, MIB decoding time and SIB decoding time. For instance, under a first proposed scheme in accordance with the present disclosure, when a wireless device (e.g., a user equipment (UE) such as a smartphone) needs to perform a cell selection procedure under an event (e.g., (i) device power-on, (ii) wireless interface switching on, (iii) NAS-triggered search, and (iv) RRC release to idle search), the device may use the frequency/frequencies and PCI(s) of one of one or more ever-camped and ever-detected cells to directly select the cell, and the device may use related stored MIB (excluding the system frame number (SFN)) and SIB. The device may also calculate the timing synchronization information such as, for example, the primary synchronization signal (PSS) and secondary synchronization signal (SSS) frame location and the SFN based on stored time information and synchronization signal block (SSB)-based radio resource management (RRM) Measurement Timing Configuration (SMTC) information. The device may then proceed to evaluate whether the cell meets a suitable condition for the device to associate with and camp on that cell. Under a second proposed scheme in accordance with the present disclosure, when the wireless device needs to perform a cell selection procedure under a certain event (e.g., (i) device power-on, (ii) wireless interface switching on, (iii) NAS-triggered search, and (iv) RRC release to idle search), the device may use a frequency and PCI of one of one or more ever-camped and ever-detected cells to directly select the cell, and the device may perform timing synchronization with the cell and decode MIB. The device may also copy stored SIB. Moreover, the device may then proceed to evaluate whether the cell meets a suitable condition for the device to associate with and camp on that cell.

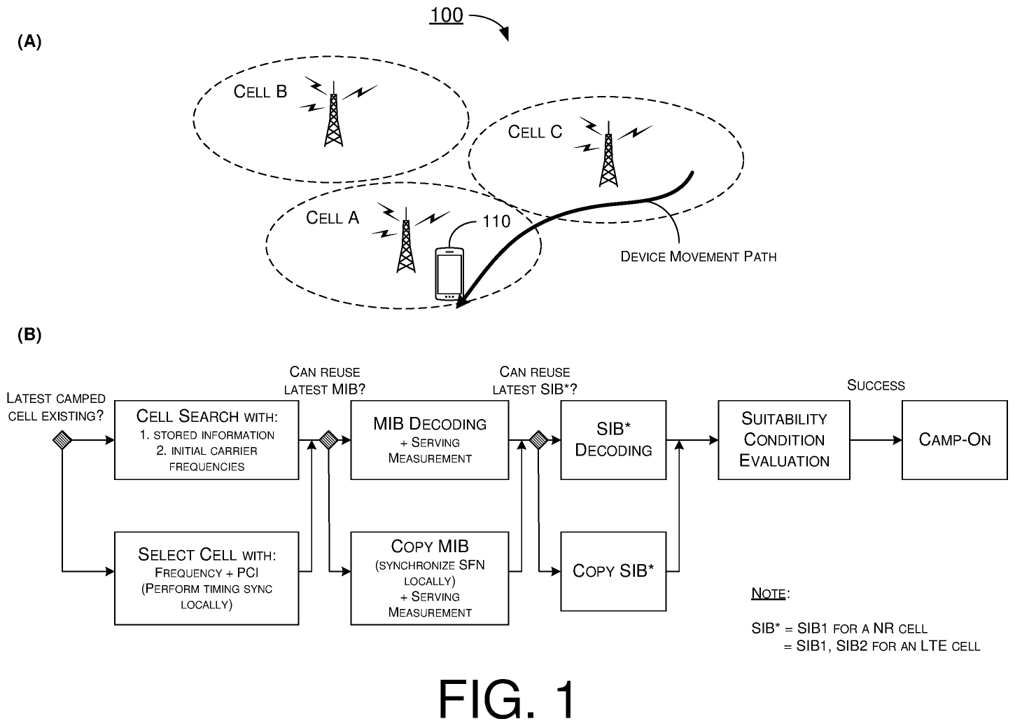

FIG. 1 illustrates an example scenario 100 under the first proposed scheme in accordance with the present disclosure. Referring to part (A) of FIG. 1, a wireless device 110 may move from being in a coverage area of one cell (e.g., Cell C) to that of another cell (e.g., Cell A) and, as such, device 110 may have detected and/or camped on each of Cell C, Cell A and Cell B at different times. Under the proposed scheme, device 110 may store information of ever-camped and ever-detected cells (e.g., Cell C, Cell A and Cell B) and related time information such as, for example and without limitation: (i) SSB-frequency and PCI, (ii) subcarrier spacing (for NR), (iii) MIB and SIB, (iv) SMTC information, and (v) time information. For instance, as shown in FIG. 1, device 110 may be camped on Cell A and has previously camped on Cell C. Also, device 110 may have detected a nearby cell (e.g., Cell B). Accordingly, from the perspective of device 110, Cell A and Cell C may be considered as “ever-camped cells” while Cell B may be considered as an “ever-detected cell.”

Device 110 may need to perform a cell selection procedure under a certain event (e.g., (i) device power-on, (ii) wireless interface switching on, (iii) NAS-triggered search, and (iv) RRC release to idle search). Under the first proposed scheme, device 110 may use the frequency/frequencies and PCI(s) of one of one or more ever-camped and ever-detected cells to directly select the cell. Device 110 may also use related stored MIB (excluding SFN) and SIB (e.g., SIB1 for a NR cell, SIB1 and SIB2 for an LTE cell) to perform serving cell measurement. For instance, device 110 may copy the MIB excluding SFN by the related MIB information. Alternatively, or additionally, device 110 may calculate the SFN by the related time information. Alternatively, or additionally, device 110 may calculate the SFN by the related SMTC information. Alternatively, or additionally, device 110 may copy the SIB by the related SIB information. Moreover, device 110 may calculate the timing synchronization information such as, for example and without limitation, PSS and SSS frame location and the SFN, by the stored time information and SMTC information. For instance, device 110 may perform the downlink synchronization to obtain the frame timing of the selected cell by related time information. Additionally, device 110 may proceed to evaluate whether the cell meets a suitable condition for the device to associate with and camp on the selected cell. Referring to part (B) of FIG. 1, the cell selection time before camp-on under a conventional cell selection procedure may include the time for the following activities: cell searching, reading MIB, reading SIB, serving cell measurement, and evaluation of suitability condition. In contrast, the cell selection time before camp-on under the ultrafast cell selection method of the first proposed scheme may include the time for the following (fewer) activities: serving cell measurement and evaluation of suitability condition. In best-case scenarios, device 110 may skip frequency and time synchronization with Cell A and/or Cell B and/or Cell C and, instead, may perform frequency and time synchronization locally without using any radio frequency (RF) receiver functionality.

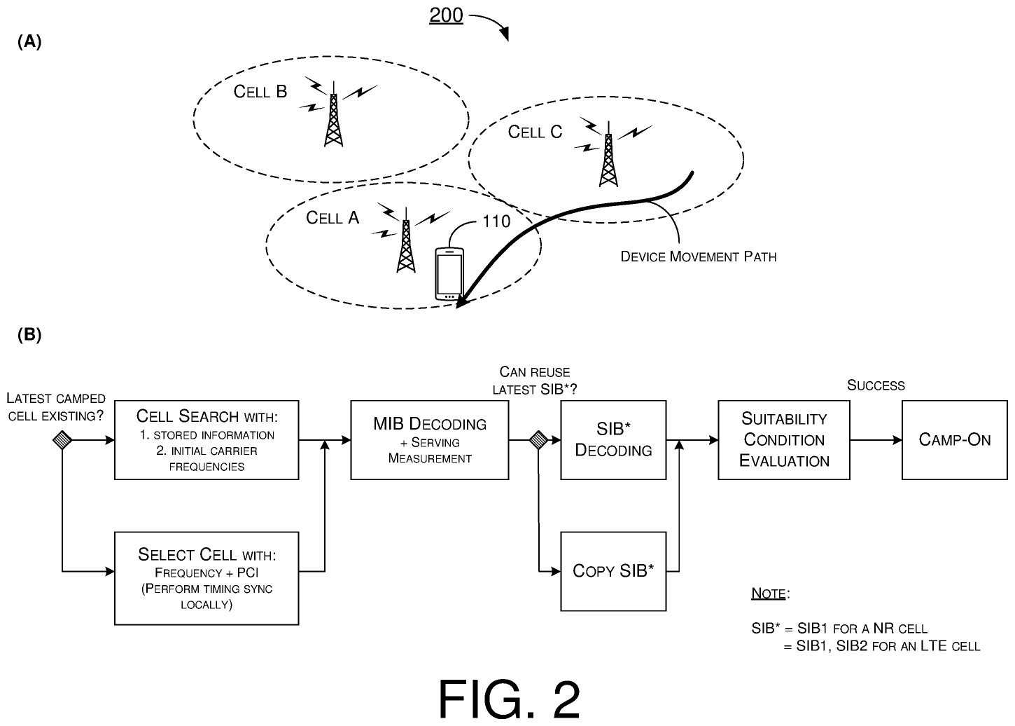

FIG. 2 illustrates an example scenario 200 under the second proposed scheme in accordance with the present disclosure. Referring to part (A) of FIG. 2, a wireless device 110 may move from being in a coverage area of one cell (e.g., Cell C) to that of another cell (e.g., Cell A) and, as such, device 110 may have detected and/or camped on each of Cell C, Cell A and Cell B at different times. Under the proposed scheme, device 110 may store information of ever-camped and ever-detected cells (e.g., Cell C, Cell A and Cell B) and related time information such as, for example and without limitation: (i) SSB-frequency and PCI, (ii) subcarrier spacing (for NR), (iii) SIB, and (iv) time information. For instance, as shown in FIG. 2, device 110 may be camped on Cell A and has previously camped on Cell C. Also, device 110 may have detected a nearby cell (e.g., Cell B). Accordingly, from the perspective of device 110, Cell A and Cell C may be considered as “ever-camped cells” while Cell B may be considered as an “ever-detected cell.”

Device 110 may need to perform a cell selection procedure under a certain event (e.g., (i) device power-on, (ii) wireless interface switching on, (iii) NAS-triggered search, and (iv) RRC release to idle search). Under the second proposed scheme, device 110 may use the frequency/frequencies and PCI(s) of one of one or more ever-camped and ever-detected cells to directly select the cell. Device 110 may perform timing synchronization with the selected cell and then decode MIB to perform serving cell measurement. For instance, device 110 may perform the downlink synchronization to obtain the frame timing of the selected cell by related time information. Additionally, device 110 may copy the stored SIB. For instance, device 110 may copy the SIB (e.g., SIB1 for a NR cell, SIB1 and SIB2 for an LTE cell) by the related SIB information. Moreover, device 110 may proceed to evaluate whether the cell meets a suitable condition for the device to associate with and camp on the selected cell. Referring to part (B) of FIG. 2, the cell selection time before camp-on under a conventional cell selection procedure may include the time for the following activities: cell searching, reading MIB, reading SIB, serving cell measurement, and evaluation of suitability condition. In contrast, the cell selection time before camp-on under the ultrafast cell selection method of the second proposed scheme may include the time for the following (fewer) activities: timing synchronization, reading MIB, serving cell measurement, and evaluation of suitability condition.

### Illustrative Implementations

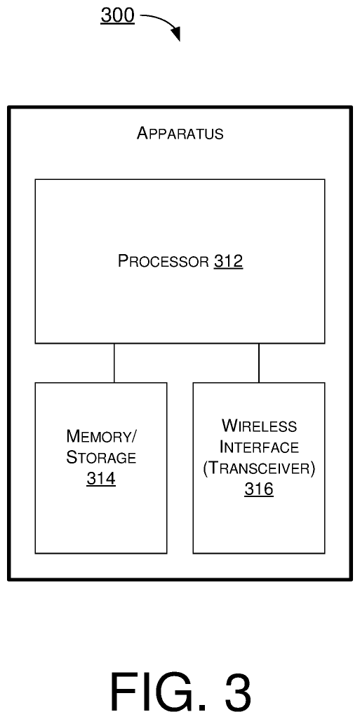

FIG. 3 illustrates an example apparatus 300 in accordance with an implementation of the present disclosure. Apparatus 300 may perform various functions to implement schemes, techniques, processes and methods described herein pertaining to ultrafast cell selection in a wireless device, including the various schemes described above with respect to various proposed designs, concepts, schemes, systems and methods described above as well as processes described below. For instance, apparatus 300 may be implemented in a user equipment (UE) or station (STA), and apparatus 300 may be an example implementation of wireless device 110 described above.

In the context of Wi-Fi, apparatus 300 may be a part of an electronic apparatus, which may be an access point (AP) STA or a non-AP STA, such as a portable or mobile apparatus, a wearable apparatus, a wireless communication apparatus or a computing apparatus. When implemented in a STA, apparatus 300 may be implemented in a smartphone, a smart watch, a personal digital assistant, a digital camera, or a computing equipment such as a tablet computer, a laptop computer or a notebook computer. Apparatus 300 may also be a part of a machine type apparatus, which may be an IoT apparatus such as an immobile or a stationary apparatus, a home apparatus, a wire communication apparatus or a computing apparatus. For instance, apparatus 300 may be implemented in a smart thermostat, a smart fridge, a smart door lock, a wireless speaker or a home control center.

In some implementations, apparatus 300 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 300 may include at least some of those components shown in FIG. 3 such as a processor 312 for example. Apparatus 300 may further include one or more other components not pertinent to the proposed scheme of the present disclosure (e.g., internal power supply, display device and/or user interface device), and, thus, such component(s) of apparatus 300 are neither shown in FIG. 3 nor described below in the interest of simplicity and brevity.

In one aspect, processor 312 may be implemented in the form of one or more single-core processors, one or more multi-core processors, one or more RISC processors or one or more CISC processors. That is, even though a singular term “a processor” is used herein to refer to processor 312, processor 312 may include multiple processors in some implementations and a single processor in other implementations in accordance with the present disclosure. In another aspect, processor 312 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 312 is a special-purpose machine specifically designed, arranged and configured to perform specific tasks including those pertaining to ultrafast cell selection in a wireless device in accordance with various implementations of the present disclosure.

In some implementations, apparatus 300 may also include a wireless interface (e.g., transceiver) 316 coupled to processor 312. Wireless interface 316 may include a transmitter capable of wirelessly transmitting and a receiver capable of wirelessly receiving data. It is noteworthy that, although wireless interface 316 is illustrated as being external to and separate from processor 312, in some implementations, wireless interface 816 may be an integral part of processor 312 as a system on chip (SoC).

In some implementations, apparatus 300 may further include a memory or storage device 314 coupled to processor 312 and capable of being accessed by processor 312 and storing data therein. In some implementations, memory or storage device 314 may include a type of random-access memory (RAM) such as dynamic RAM (DRAM), static RAM (SRAM), thyristor RAM (T-RAM) and/or zero-capacitor RAM (Z-RAM). Alternatively, or additionally, memory or storage device 314 may include a type of read-only memory (ROM) such as mask ROM, programmable ROM (PROM), erasable programmable ROM (EPROM) and/or electrically erasable programmable ROM (EEPROM). Alternatively, or additionally, memory or storage device 314 may include a type of non-volatile random-access memory (NVRAM) such as flash memory, solid-state memory, ferroelectric RAM (FeRAM), magnetoresistive RAM (MRAM) and/or phase-change memory.

Under various proposed schemes pertaining to ultrafast cell selection in a wireless device in accordance with the present disclosure, processor 312 of apparatus 300, implemented in or as wireless device 110, may store, in memory or storage device 314, information related to at least one of: (a) one or more ever-camped cells having been camped on by apparatus 300 previously, and (b) one or more ever-detected cells having been detected by apparatus 300 previously. Moreover, processor 312 may perform, via wireless interface 316, a cell selection procedure using the stored information responsive to occurrence of an event.

In some implementations, the event may include one of the following: (i) power-on of apparatus 300; (ii) wireless interface of apparatus 300 switching on; (iii) NAS-triggered search; and (iv) RRC release to idle search.

In some implementations, the stored information may include some or all of the following: (i) a frequency and a PCI of each of the one or more ever-camped cells and the one or more ever-detected cells; (ii) a subcarrier spacing (in case of a NR cell); (iii) MIB and SIB information; (iv) SMTC information; and (v) time information.

In some implementations, in performing the cell selection procedure, processor 312 may perform certain operations. For instance, processor 312 may select a cell using the frequency and the PCI of one of the one or more ever-camped cells or one of the one or more ever-detected cells. Additionally, processor 312 may select the cell using either of: (a) the MIB and SIB information from the stored information, or (b) the SIB information from the stored information. The SIB information may include SIB1 for a NR cell or SIB1+SIB2 for a LTE cell. Moreover, processor 312 may estimate and select one of the one or more ever-camped cells and the one or more ever-detected cells as the selected cell. Furthermore, processor 312 may perform downlink synchronization to obtain a frame timing of the selected cell using the stored information.

In some implementations, in using the MIB information, processor 312 may copy a MIB excluding a SFN. In some implementations, in performing the cell selection procedure, processor 312 may calculate the SFN using the SMTC information or the time information from the stored information.

### Illustrative Processes

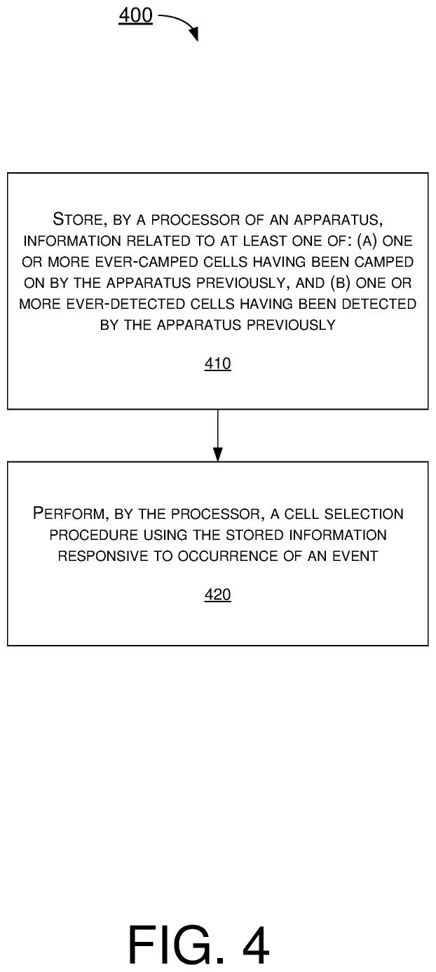

FIG. 4 illustrates an example process 400 in accordance with an implementation of the present disclosure. Process 400 may represent an aspect of implementing various proposed designs, concepts, schemes, systems and methods described above, whether partially or entirely, including those described above. More specifically, process 400 may represent an aspect of the proposed concepts and schemes pertaining to ultrafast cell selection in a wireless device. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 300 as well as any variations thereof. Solely for illustrative purposes and without limiting the scope, process 400 is described below in the context of apparatus 300 as a wireless device (e.g., wireless device 110) in scenario 100. Process 400 may begin at block 410.

At 410, process 400 may involve processor 312 of apparatus 300, implemented in or as wireless device 110, storing, in memory or storage device 314, information related to at least one of: (a) one or more ever-camped cells having been camped on by apparatus 300 previously, and (b) one or more ever-detected cells having been detected by apparatus 300 previously. Process 400 may proceed from 410 to 420.

At 420, process 400 may involve processor 312 performing, via wireless interface 316, a cell selection procedure using the stored information responsive to occurrence of an event.

In some implementations, the event may include one of the following: (i) power-on of apparatus 300; (ii) wireless interface of apparatus 300 switching on; (iii) NAS-triggered search; and (iv) RRC release to idle search.

In some implementations, the stored information may include some or all of the following: (i) a frequency and a PCI of each of the one or more ever-camped cells and the one or more ever-detected cells; (ii) a subcarrier spacing (in case of a NR cell); (iii) MIB and SIB information; (iv) SMTC information; and (v) time information.

In some implementations, in performing the cell selection procedure, process 400 may involve processor 312 performing certain operations. For instance, process 400 may involve processor 312 selecting a cell using the frequency and the PCI of one of the one or more ever-camped cells or one of the one or more ever-detected cells. Additionally, process 400 may involve processor 312 selecting the cell using either of: (a) the MIB and SIB information from the stored information, or (b) the SIB information from the stored information. The SIB information may include SIB1 for a NR cell or SIB1+SIB2 for a LTE cell. Moreover, process 400 may involve processor 312 estimating and selecting one of the one or more ever-camped cells and the one or more ever-detected cells as the selected cell. Furthermore, process 400 may involve processor 312 performing downlink synchronization to obtain a frame timing of the selected cell using the stored information.

In some implementations, in using the MIB information, process 400 may involve processor 312 copying a MIB excluding a SFN. In some implementations, in performing the cell selection procedure, process 400 may also involve processor 312 calculating the SFN using the SMTC information or the time information from the stored information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method of ultrafast cell selection, comprising:
storing, by a processor of an apparatus, information related to at least one of:
one or more ever-camped cells having been camped on by the apparatus previously, and
one or more ever-detected cells having been detected by the apparatus previously; and
performing, by the processor, a cell selection procedure using the stored information responsive to occurrence of an event.

2. The method of claim 1, wherein the event comprises one of:
power-on of the apparatus;
wireless interface of the apparatus switching on;
non-access stratum (NAS)-triggered search; and
radio resource control (RRC) release to idle search.

3. The method of claim 1, wherein the stored information comprises some or all of:
a frequency and a physical-layer cell identity (PCI) of each of the one or more ever-camped cells and the one or more ever-detected cells;
a subcarrier spacing;
master information block (MIB) and system information block (SIB) information;
synchronization signal block (SSB)-based radio resource management (RRM) Measurement Timing Configuration (SMTC) information; and
time information.

4. The method of claim 3, wherein the performing of the cell selection procedure comprises selecting a cell using the frequency and the PCI of one of the one or more ever-camped cells or one of the one or more ever-detected cells.

5. The method of claim 4, wherein the performing of the cell selection procedure further comprises selecting the cell using:
the MIB and SIB information from the stored information, or
the SIB information from the stored information.

6. The method of claim 5, wherein the performing of the cell selection procedure further comprises estimating and selecting one of the one or more ever-camped cells and the one or more ever-detected cells as the selected cell.

7. The method of claim 6, wherein the performing of the cell selection procedure further comprises performing downlink synchronization to obtain a frame timing of the selected cell using the stored information.

8. The method of claim 5, wherein the using of the MIB information comprises copying a MIB excluding a system frame number (SFN).

9. The method of claim 8, wherein the performing of the cell selection procedure further comprises calculating the SFN using the SMTC information or the time information from the stored information.

10. The method of claim 5, wherein the SIB information comprises SIB1 for a New Radio (NR) cell or SIB1 and SIB2 for a Long-Term Evolution (LTE) cell.

11. An apparatus, comprising:
a wireless interface;
a memory; and
a processor coupled to the wireless interface and the memory, the processor configured to perform operations comprising:
storing, in the memory, information related to at least one of:
one or more ever-camped cells having been camped on by the apparatus previously, and
one or more ever-detected cells having been detected by the apparatus previously; and
performing, via the wireless interface, a cell selection procedure using the stored information responsive to occurrence of an event.

12. The apparatus of claim 11, wherein the event comprises one of:
power-on of the apparatus;
wireless interface of the apparatus switching on;
non-access stratum (NAS)-triggered search; and
radio resource control (RRC) release to idle search.

13. The apparatus of claim 11, wherein the stored information comprises some or all of:
a frequency and a physical-layer cell identity (PCI) of each of the one or more ever-camped cells and the one or more ever-detected cells;
a subcarrier spacing;
master information block (MIB) and system information block (SIB) information;
synchronization signal block (SSB)-based radio resource management (RRM) Measurement Timing Configuration (SMTC) information; and
time information.

14. The apparatus of claim 13, wherein, in performing the cell selection procedure, the processor is configured to select a cell using the frequency and the PCI of one of the one or more ever-camped cells or one of the one or more ever-detected cells.

15. The apparatus of claim 14, wherein, in performing the cell selection procedure, the processor is further configured to select the cell using:
the MIB and SIB information from the stored information, or
the SIB information from the stored information.

16. The apparatus of claim 15, wherein, in performing the cell selection procedure, the processor is further configured to estimate and select one of the one or more ever-camped cells and the one or more ever-detected cells as the selected cell.

17. The apparatus of claim 16, wherein, in performing the cell selection procedure, the processor is further configured to perform downlink synchronization to obtain a frame timing of the selected cell using the stored information.

18. The apparatus of claim 15, wherein, in using the MIB information, the processor is configured to copy a MIB excluding a system frame number (SFN).

19. The apparatus of claim 18, wherein, in performing the cell selection procedure, the processor is further configured to calculate the SFN using the SMTC information or the time information from the stored information.

20. The apparatus of claim 15, wherein the SIB information comprises SIB1 for a New Radio (NR) cell or SIB1 and SIB2 for a Long-Term Evolution (LTE) cell.
